(19) United States
(12) Patent Application Publication
(10) Pub. No.: US 2024/0215628 A1
(43) Pub. Date: Jul. 4, 2024

(54) SYSTEM AND METHOD FOR IMPROVING FOOD INTAKE OF POULTRY AND ANIMALS BASED ON MAGNETIC FIELDS APPLICATION

(71) Applicant: Alireza Fadaee outan, Tehran (IR)

(72) Inventor: Alireza Fadaee outan, Tehran (IR)

(21) Appl. No.: 18/557,939

(22) PCT Filed: May 1, 2021
(86) PCT No.: PCT/IB2021/053655

§ 371 Date: Oct. 29, 2023

(51) Int. Cl. A23N 17/00; A01K 5/02; A01K 39/01; A23K 40/00

(52) U.S. Cl. CPC A23N 17/00; A01K 5/02; A01K 39/01; A23K 40/00

(57) ABSTRACT

A system for improving livestock and poultry feed may include a non-magnetic conduit, a feeding mechanism configured to transfer livestock and poultry feed into the non-magnetic conduit, and a magnetic fields generation mechanism that may include a plurality of magnets arranged around the non-magnetic conduit. The magnetic fields generation mechanism configured to subject the transferred livestock and poultry feed to magnetic fields. The system may subject the livestock and poultry feed to magnetic fields for a period of 40 to 45 minutes.

### TECHNICAL FIELD

The present disclosure is related to a system and method for improving food intake and food digestion rate and reducing the required time for taking the nutrition in and digesting it, and particularly to enriching animal and poultry feed utilizing magnetic fields.

### BACKGROUND

A careful analysis of digestive systems in poultry and other creatures reveals that the presence of enzymes influencing feed is an inseparable part of turning food into primary structures. The ingredients used in poultry, livestock and even human food will need a certain amount of time to pass through the digestive system, decompose and be absorbed after consumption. This amount of time is often not enough for full decomposition and digestion of food especially starch and cellulose. Consequently, some of the food always passes through the bowels without being digested. To increase the absorption efficiency, several methods are used, and the most common methods are using simple sugars, such as maltose or artificially increasing the number of decomposing enzymes. However, since food remains inside the digestive system for a relatively short time and enzymes cannot change starch into maltose very efficiently, starch and other structurally similar molecules decomposition efficiency is extremely low.

A high volume of starch molecules are commonly made up of a combination of continuous linear glucose molecules or networks of glucose molecules. Starch has two linear shapes of amylose and amylopectin which, compared to simple sugars, are much harder to decompose. The force required to break the complicated starch bonds using alpha-amylase and beta-amylase enzymes and the force and time required to break the bonds and produce maltose are certain amounts that can differ depending on how far components of starch are located from one another.

Therefore, developing a system and method that may allow for destabilizing the complicated starch bonds by changing bond angles to obtuse angles may be crucial for decrease the force required to break up the bonds between glucose and oxygen in disaccharide molecules. Such system may allow for improving food intake and food digestion rate and reducing the required time for taking the nutrition in and digesting it.

### BRIEF DESCRIPTION OF FIGURES

The novel features which are believed to be characteristic of the present disclosure, as to its structure, organization, use and method of operation, together with further objectives and advantages thereof, will be better understood from the following drawings in which a presently preferred embodiment of the present disclosure will now be illustrated by way of example. It is expressly understood, however, that the drawings are for illustration and description only and are not intended as a definition of the limits of the present disclosure. Embodiments of the present disclosure will now be described by way of example in association with the accompanying drawings in which:

FIG. 1A illustrates a schematic sectional side view of a system for improving livestock and poultry feed utilizing ring magnets, consistent with one or more exemplary embodiments of the present disclosure;

FIG. 1B illustrates a schematic sectional top view of a system for improving livestock and poultry feed utilizing ring magnets, consistent with one or more exemplary embodiments of the present disclosure;

FIG. 2 illustrates a schematic perspective view of an axially magnetized permanent magnet ring, consistent with one or more exemplary embodiments of the present disclosure;

FIG. 3A illustrates magnetic field lines generated by a first plurality of axially magnetized permanent magnet rings with each pair of adjacent axially magnetized permanent magnet rings facing each other with faces having similar polarities, consistent with one or more exemplary embodiments of the present disclosure;

FIG. 3B illustrates magnetic field lines generated by a second plurality of axially magnetized permanent magnet rings with each pair of adjacent axially magnetized permanent magnet rings facing each other with faces having opposite polarities, consistent with one or more exemplary embodiments of the present disclosure;

FIG. 4A illustrates a schematic sectional side view of a system for improving livestock and poultry feed utilizing slab magnets, consistent with one or more exemplary embodiments of the present disclosure;

FIG. 4B illustrates a schematic sectional top view of a system for improving livestock and poultry feed utilizing slab magnets, consistent with one or more exemplary embodiments of the present disclosure;

FIG. 5A illustrates a schematic sectional side view of a system for improving livestock and poultry feed utilizing bar magnets, consistent with one or more exemplary embodiments of the present disclosure;

FIG. 5B illustrates a schematic sectional top view of a system for improving livestock and poultry feed utilizing bar magnets, consistent with one or more exemplary embodiments of the present disclosure; and

FIG. 6 illustrates a schematic sectional side view of a system for improving livestock and poultry feed utilizing at least one electromagnet, consistent with one or more exemplary embodiments of the present disclosure.

### DETAILED DESCRIPTION

The novel features which are believed to be characteristic of the present disclosure, as to its structure, organization, use and method of operation, together with further objectives and advantages thereof, will be better understood from the following discussion.

According to one or more exemplary embodiments, the present disclosure is directed to systems and methods for improving feed conversion ratio (FCR). Feed conversion ratio shows the management efficiency of a flock during a breeding course. It is an indirect indicator of a flock's profit in return for a certain amount of feed since in meat poultries, feeding costs can amount to 70% of the overall costs of a breeding course. As a result, improving the ability of poultry to convert feed into meat will be a deciding factor for their profitability. This means that even a small change in FCR may have a significant impact on the profit and financial aspects of the flock. Consequently, the present disclosure is directed to systems and methods for improving FCR by increasing live poultry weight, decreasing feed consumption, and decreasing feed wastage.

According to one or more exemplary embodiments, the present disclosure is directed to a system and method for improving livestock and poultry feed by applying magnetic fields on livestock and poultry feed. Such application of magnetic field may allow for destabilizing the complicated bonds of starch and other structurally similar molecules present in livestock and poultry feed by changing bond angles to obtuse angles. An exemplary system and method for improving livestock and poultry feed may allow for changing the bond angles within a feed by applying magnetic fields on the feed utilizing carefully arranged magnets, which will be discussed in the following section of the present disclosure.

Regarding the effect of magnetic fields on different molecules, such as water molecules, if the central bond such as oxygen has more electronegativity compared to the adjacent pairs, being placed in a magnetic field causes the pairs of the oxygen bond with two hydrogens to retract and if the electronegativity in the lateral pairs is more, the presence of a magnetic field causes the oxygen pairs to extend. Therefore, in a disaccharide bond such as maltose, the presence of a magnetic field causes the bond angles to become obtuse which can destabilize the bond and decrease the force needed to break up the bond between glucose and oxygen in disaccharide molecules.

Complex molecules of starch are commonly made up of a primary chain in the form of a spiral on which multiple similar pairs with similar directions exists at certain distances; each pair plays the role of a spiral on which several connected chains exist. The final crystalline form of starch resembles a wheat cluster with thousands of clusters instead of each seed. Here, alpha-amylase and beta-amylase, as the two enzymes used for breaking up amylopectin bonds (starch), attack the chain from a certain section, break the starch and turn it into maltose. Putting starch molecules in a magnetic field on the one hand causes the bond angle between two glucose molecules to become obtuse and makes it easier for starch decomposing enzymes to break up these bonds, and on the other hand, increasing the angle between glucose molecules (where a chain is connected to another chain) forces the clusters made up of connected amylose to open, and this obtuse angle and the flourishing of starch crystal paves the way for enzymes to enter the central part of the crystal. In other words, magnetizing the feed during the breaking up of bonds provides better results in a shorter period, and reduces the time needed to access and decompose starch molecules. The maltose resulted from amylopectin decomposition is hydrated in the vicinity of water molecules and releases two glucose molecules. The same thing happens for cellulose due to its high structural similarity with starch. However, considering the final crystalline form of starch and the clusters, the increase in angle will play a significant role in separating amylose chains and penetrability of alpha-amylose and beta-amylose.

An exemplary system for improving livestock and poultry feed may include a non-magnetic conduit, a feeding mechanism that may be configured to transfer livestock and poultry feed into an exemplary non-magnetic conduit, and a magnetic field generation mechanism that may include a plurality of magnets arranged around an exemplary non-magnetic conduit. An exemplary magnetic field generation mechanism may be configured to subject exemplary transferred livestock and poultry feed to magnetic fields.

An exemplary magnetic field generation mechanism may include a plurality of axially magnetized permanent magnet rings. Each exemplary permanent magnet ring may be fitted coaxially around an exemplary non-magnetic conduit. The plurality of exemplary axially magnetized permanent magnet rings may be mounted along a length of an exemplary non-magnetic conduit with a predetermined longitudinal distance between each pair of adjacent axially magnetized permanent magnet rings of the plurality of exemplary axially magnetized permanent magnet rings.

A plurality of exemplary axially magnetized permanent magnet rings may be mounted on an exemplary non-magnetic conduit with an axis of symmetry of each axially magnetized permanent magnet ring of the plurality of exemplary axially magnetized permanent magnet rings parallel with a longitudinal axis of an exemplary non-magnetic conduit. A central hole of each axially magnetized permanent magnet ring of the plurality of exemplary axially magnetized permanent magnet rings may encompass an exemplary non-magnetic conduit.

Each axially magnetized permanent magnet ring of a plurality of exemplary axially magnetized permanent magnet rings may include a first face with a first polarity and a second face with a second polarity. An exemplary first face and an exemplary second face may be perpendicular to an exemplary axis of symmetry of an exemplary permanent magnet ring.

Each pair of adjacent axially magnetized permanent magnet rings of a plurality of exemplary axially magnetized permanent magnet rings may be facing each other with faces having opposite polarities.

Each pair of adjacent axially magnetized permanent magnet rings of a plurality of exemplary axially magnetized permanent magnet rings may be facing each other with faces having similar polarities.

A plurality of exemplary axially magnetized permanent magnet rings may include a first axially magnetized permanent magnet ring, and a second axially magnetized permanent magnet ring that may be positioned at the predetermined longitudinal distance away from an exemplary first axially magnetized permanent magnet ring. An exemplary first face of an exemplary first axially magnetized permanent magnet ring with a first polarity may be positioned facing a second face of an exemplary second axially magnetized permanent magnet ring with a second polarity. An exemplary first polarity and an exemplary second polarity may be opposite polarities.

An inner diameter of each axially magnetized permanent magnet ring of a plurality of exemplary axially magnetized permanent magnet rings may be equal to an outer diameter of an exemplary non-magnetic conduit.

An exemplary system for improving livestock and poultry feed may further include an elongated housing that may be coaxially disposed around an exemplary non-magnetic conduit. An exemplary elongated housing may be extended along an exemplary longitudinal axis of an exemplary non-magnetic conduit. An exemplary elongated housing may be coaxial with and encompassing a plurality of exemplary axially magnetized permanent magnet rings such that the plurality of axially magnetized permanent magnet rings may be disposed between an exemplary elongated housing and an exemplary non-magnetic conduit.

An exemplary the magnetic field generation mechanism may include a plurality of slab magnets that may be arranged around an exemplary non-magnetic conduit. A plurality of exemplary slab magnets may be mounted along a length of an exemplary non-magnetic conduit with a predetermined longitudinal distance between each pair of adjacent slab magnets of a plurality of exemplary slab magnets.

An exemplary magnetic field generation mechanism may include a plurality of magnet bars arranged around an exemplary non-magnetic conduit. A plurality of exemplary magnet bars may be mounted along a length of an exemplary non-magnetic conduit with a predetermined longitudinal distance between each pair of adjacent magnet bars of a plurality of exemplary magnet bars.

An exemplary method for improving livestock and poultry feed may include generating a magnetic field in livestock and poultry feed by arranging a plurality of axially magnetized permanent magnet rings around a conduit containing the livestock and poultry feed. Each exemplary permanent magnet ring of a plurality of exemplary axially magnetized permanent magnet rings may be fitted coaxially around an exemplary conduit. A plurality of exemplary axially magnetized permanent magnet rings may be mounted along a length of an exemplary conduit with a predetermined longitudinal distance between each pair of adjacent axially magnetized permanent magnet rings of a plurality of exemplary axially magnetized permanent magnet rings.

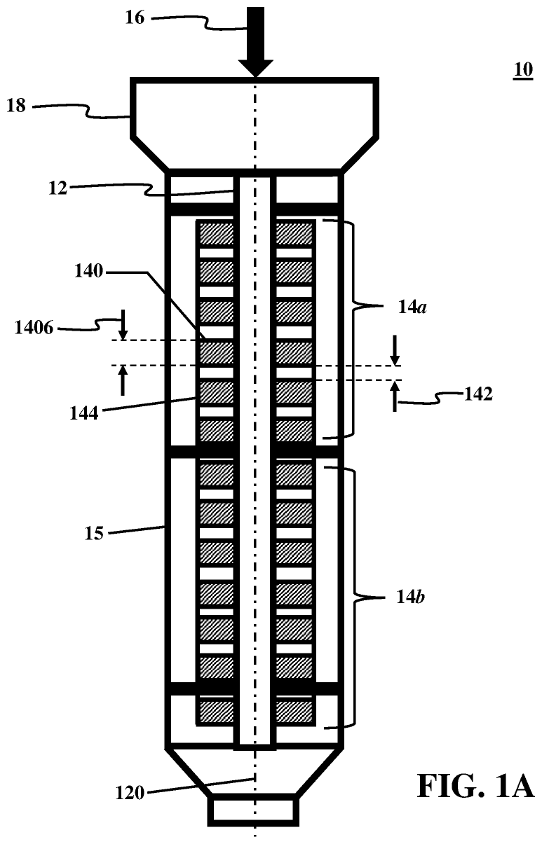

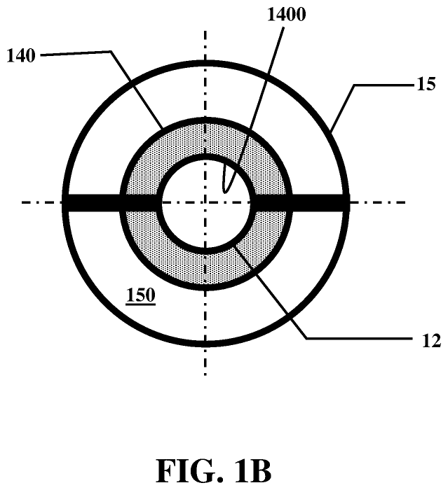

FIG. 1A illustrates a system 10 for improving livestock and poultry feed, consistent with one or more exemplary embodiments of the present disclosure. FIG. 1B illustrates a schematic sectional top view of system 10 for improving livestock and poultry feed utilizing ring magnets, consistent with one or more exemplary embodiments of the present disclosure.

In an exemplary embodiment, system 10 may include a non-magnetic conduit 12 and a plurality of axially magnetized permanent magnet rings (14a and 14b) that may be mounted coaxially around non-magnetic conduit 12. In an exemplary embodiment, plurality of axially magnetized permanent magnet rings (14a and 14b) may be mounted along a length of non-magnetic conduit 12 with a predetermined longitudinal distance between each pair of adjacent axially magnetized permanent magnet rings of plurality of axially magnetized permanent magnet rings (14a and 14b). For example, axially magnetized permanent magnet ring 140 may be mounted at a predetermined longitudinal distance 142 from axially magnetized permanent magnet ring 144. In an exemplary embodiment, plurality of axially magnetized permanent magnet rings (14a and 14b) may be mounted on non-magnetic conduit 12 with an axis of symmetry of each axially magnetized permanent magnet ring of plurality of axially magnetized permanent magnet rings (14a and 14b) being parallel with a longitudinal axis 120 of non-magnetic conduit 12. In an exemplary embodiment, a central hole of each axially magnetized permanent magnet ring of plurality of axially magnetized permanent magnet rings (14a and 14b) may encompass non-magnetic conduit 12. For example, central hole 1400 of axially magnetized permanent magnet ring 140 may encompass non-magnetic conduit 12. As used herein, central hole 1400 of axially magnetized permanent magnet ring 140 encompassing non-magnetic conduit 12 may refer to non-magnetic conduit 12 passing through central hole 1400.

In an exemplary embodiment, system 10 may further include an elongated housing 15 that may be coaxially disposed around non-magnetic conduit 12. In an exemplary embodiment, elongated housing 15 may extend along longitudinal axis 120 of non-magnetic conduit 12. Elongated housing 15 may be coaxial with and encompassing plurality of axially magnetized permanent magnet rings (14a and 14b) such that plurality of axially magnetized permanent magnet rings (14a and 14b) may be disposed between elongated housing 15 and non-magnetic conduit 12. In an exemplary embodiment, a hollow space between outer surfaces of plurality of axially magnetized permanent magnet rings (14a and 14b) and an inner surface of elongated housing 15 may further provide an outer conduit 150 for receiving livestock and poultry feed in system 10, as will be discussed.

In an exemplary embodiment, livestock and poultry feed may be transferred into system 10 via non-magnetic conduit 12 and outer conduit 150. Then, the livestock and poultry feed received within system 10 may be subjected to magnetic fields generated by plurality of axially magnetized permanent magnet rings (14a and 14b). In an exemplary embodiment, livestock and poultry feed may be subjected to magnetic fields generated by plurality of axially magnetized permanent magnet rings (14a and 14b) for a period of between 40 and 45 minutes and then the magnetized livestock and poultry feed may be discharged from non-magnetic conduit 12. After passing through the magnetic field or fields provided by plurality of axially magnetized permanent magnet rings (14a and 14b), the feed will move to the section where it can be used by poultry, livestock or aquatic animals.

In an exemplary embodiment, the predetermined longitudinal distance between each pair of adjacent axially magnetized permanent magnet rings may be between 0.25 and 1 times the width of each axially magnetized permanent magnet ring. For example, predetermined longitudinal distance 142 between axially magnetized permanent magnet ring 140 and axially magnetized permanent magnet ring 144 may be between 0.25 and 1 times a width 1406 of axially magnetized permanent magnet ring 140. In an exemplary embodiment, plurality of axially magnetized permanent magnet rings (14a and 14b) may be structured similarly with similar widths.

In an exemplary embodiment, system 10 may further include a feeding funnel 18, through which livestock and poultry feed 16 may be transferred into non-magnetic conduit 12 and outer conduit 150. In an exemplary embodiment, livestock and poultry feed 16 may be transported from a silo to feeding funnel 18 utilizing a conveying mechanism, such as a screw conveyor.

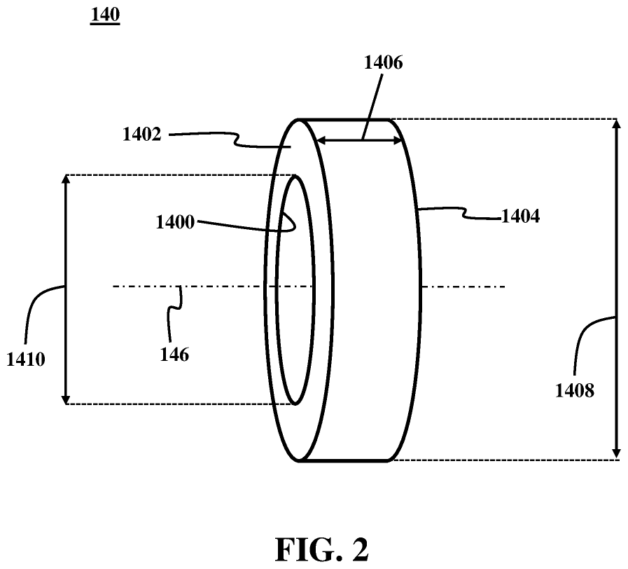

FIG. 2 illustrates a schematic perspective view of axially magnetized permanent magnet ring 140, consistent with one or more exemplary embodiments of the present disclosure. In an exemplary embodiment, each axially magnetized permanent magnet ring of plurality of axially magnetized permanent magnet rings (14a and 14b) may include a first face with a first polarity and a second face with a second polarity, where the first face and the second face may be perpendicular to an axis of symmetry of each axially magnetized permanent magnet ring of plurality of axially magnetized permanent magnet rings (14a and 14b). For example, axially magnetized permanent magnet ring 140 may include a first face 1402 with a first polarity and a second face 1404 with a second polarity, where first face 1402 and second face 1404 may be perpendicular to axis of symmetry 146 of axially magnetized permanent magnet ring 140. In an exemplary embodiment, the first polarity may be one of north (N) or south (S) and the second polarity may be one of N or S. As used herein, permanent magnet ring 140 being axially magnetized may refer to first face 1402 having a first polarity, for example N, and second face 1404 having an opposite polarity, for example S.

In an exemplary embodiment, each pair of adjacent axially magnetized permanent magnet rings of plurality of axially magnetized permanent magnet rings (14a and 14b) may be facing each other with faces having opposite polarities. For example, axially magnetized permanent magnet ring 140 may face axially magnetized permanent magnet ring 144 with faces with opposite polarities, i.e., axially magnetized permanent magnet ring 140 may face axially magnetized permanent magnet ring 144 with a face of N polarity, while axially magnetized permanent magnet ring 144 faces axially magnetized permanent magnet ring 140 with a face of S polarity or vice versa.

In an exemplary embodiment, each pair of adjacent axially magnetized permanent magnet rings of plurality of axially magnetized permanent magnet rings (14a and 14b) may be facing each other with faces having similar polarities. For example, axially magnetized permanent magnet ring 140 may face axially magnetized permanent magnet ring 144 with faces with similar polarities, i.e., axially magnetized permanent magnet ring 140 may face axially magnetized permanent magnet ring 144 with a face of N polarity, and axially magnetized permanent magnet ring 144 may also face axially magnetized permanent magnet ring 140 with a face of N polarity.

In an exemplary embodiment, a first plurality of axially magnetized permanent magnet rings 14a may be configured such that each pair of adjacent axially magnetized permanent magnet rings of first plurality of axially magnetized permanent magnet rings 14a may be facing each other with faces having similar polarities. In an exemplary embodiment, a second plurality of axially magnetized permanent magnet rings 14b may be configured such that each pair of adjacent axially magnetized permanent magnet rings of second plurality of axially magnetized permanent magnet rings 14b may be facing each other with faces having opposite polarities. In an exemplary embodiment, such arrangement may be vice versa, i.e. each pair of adjacent axially magnetized permanent magnet rings of first plurality of axially magnetized permanent magnet rings 14a may be facing each other with faces having opposite polarities while each pair of adjacent axially magnetized permanent magnet rings of second plurality of axially magnetized permanent magnet rings 14b may be facing each other with faces having similar polarities. However, for the sake of simplicity only one arrangement is discussed here.

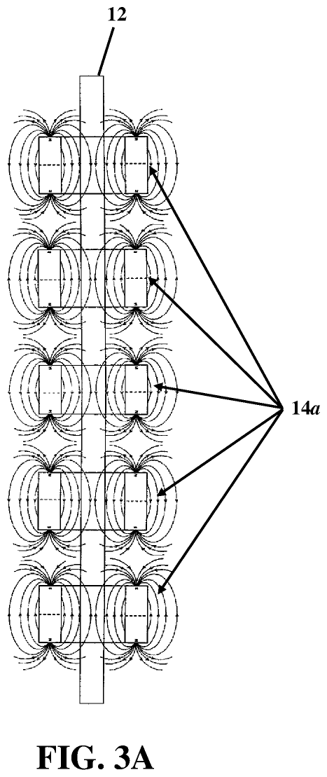

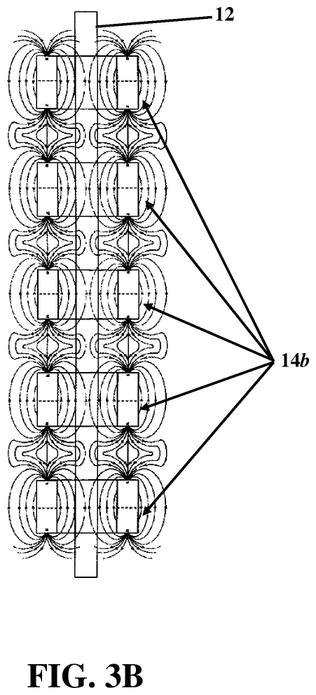

FIG. 3A illustrates magnetic field lines generated by first plurality of axially magnetized permanent magnet rings 14a with each pair of adjacent axially magnetized permanent magnet rings facing each other with faces having similar polarities, consistent with one or more exemplary embodiments of the present disclosure. FIG. 3B illustrates magnetic field lines generated by second plurality of axially magnetized permanent magnet rings 14b with each pair of adjacent axially magnetized permanent magnet rings facing each other with faces having opposite polarities, consistent with one or more exemplary embodiments of the present disclosure.

In an exemplary embodiment, plurality of axially magnetized permanent magnet rings (14a and 14b) may include a first axially magnetized permanent magnet ring such as axially magnetized permanent magnet ring 140 and a second axially magnetized permanent magnet ring such as axially magnetized permanent magnet ring 144 that may be positioned at a predetermined longitudinal distance such as predetermined longitudinal distance 142 away from the first axially magnetized permanent magnet ring. In an exemplary embodiment, a first face of the first axially magnetized permanent magnet ring with a first polarity (either S or N) may be positioned facing a second face of the second axially magnetized permanent magnet ring with a second polarity (either S or N). In an exemplary embodiment, the first polarity and the second polarity may be opposite polarities. In an exemplary embodiment, the first polarity and the second polarity may be similar polarities.

In an exemplary embodiment, a predetermined longitudinal distance between each pair of adjacent axially magnetized permanent magnet rings of plurality of axially magnetized permanent magnet rings (14a and 14b) may be between 2 mm and 10 mm. For example, longitudinal distance 142 between axially magnetized permanent magnet ring 140 and axially magnetized permanent magnet ring 144 may be between 2 mm and 10 mm.

In an exemplary embodiment, a thickness of each axially magnetized permanent magnet ring of plurality of axially magnetized permanent magnet rings (14a and 14b) may be between 5 mm and 50 mm. For example, a thickness 1406 of axially magnetized permanent magnet ring 140 may be between 5 mm and 50 mm.

In an exemplary embodiment, an outer diameter of each axially magnetized permanent magnet ring of plurality of axially magnetized permanent magnet rings (14a and 14b) may be between 10 mm and 300 mm. For example, an outer diameter 1408 of axially magnetized permanent magnet ring 140 may be between 10 mm and 300 mm.

In an exemplary embodiment, an inner diameter of each axially magnetized permanent magnet ring of plurality of axially magnetized permanent magnet rings (14a and 14b) may be equal to an outer diameter 122 of non-magnetic conduit 12. For example, an inner diameter 1410 of axially magnetized permanent magnet ring 140 may be equal to an outer diameter 122 of non-magnetic conduit 12. In an exemplary embodiment, inner diameter 1410 of axially magnetized permanent magnet ring 140 may be in a range of 5 mm to 150 mm.

According to one or more exemplary embodiments, the present disclosure is further directed to a system for improving livestock and poultry feed, in which magnetic field generation mechanism may include a plurality of slab magnets disposed between each side of a non-magnetic conduit and an outer housing or conduit encompassing the plurality of slab magnets. Exemplary slab magnets may be arranged at both sides of an exemplary non-magnetic conduit along a longitudinal axis of an exemplary non-magnetic conduit. In an exemplary embodiment, exemplary slab magnets may be arranged around an exemplary non-magnetic conduit, such that a pair of slab magnets of exemplary slab magnets may be aligned at opposite sides of an exemplary non-magnetic conduit along an axis perpendicular to an exemplary longitudinal axis of an exemplary non-magnetic conduit. In an exemplary embodiment, exemplary slab magnets may be arranged such that every other pair of slab magnets mounted on opposite sides of an exemplary non-magnetic conduit may face each other with opposite poles and other remaining pair of slab magnets may face each other with similar poles, which will be discussed later.

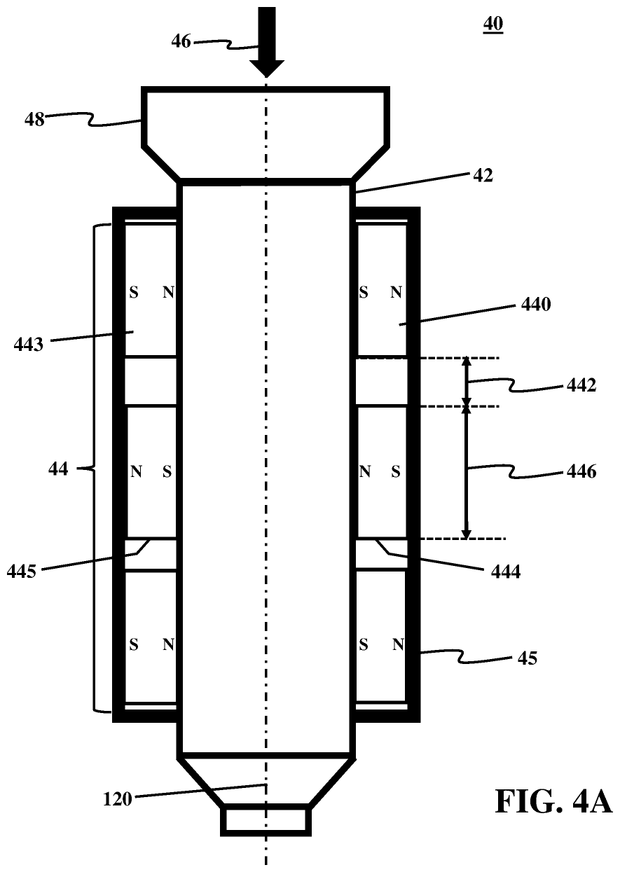

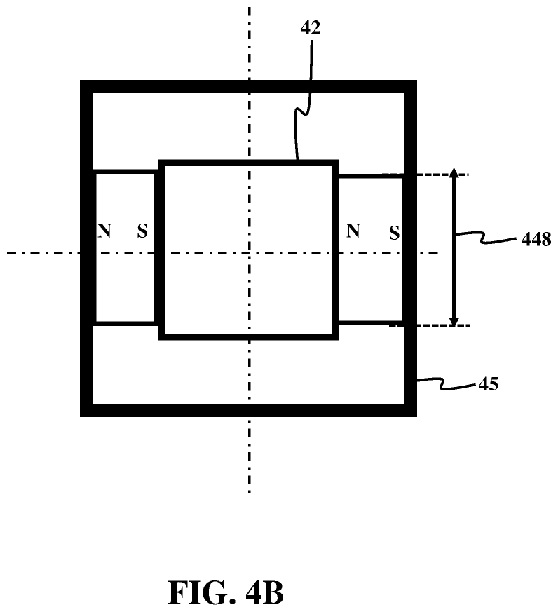

FIG. 4A illustrates a schematic sectional side view of a system 40 for improving livestock and poultry feed utilizing slab magnets, consistent with one or more exemplary embodiments of the present disclosure. FIG. 4B illustrates a schematic sectional top view of system 40 for improving livestock and poultry feed utilizing slab magnets, consistent with one or more exemplary embodiments of the present disclosure.

In an exemplary embodiment, system 40 may be configured similar to system 10 to apply magnetic fields on livestock and poultry feeds. In an exemplary embodiment, system 40 may include a non-magnetic conduit 42 similar to non-magnetic conduit 12, which may be configured for receiving and holding livestock and poultry feed during treatment with magnetic fields. In an exemplary embodiment, system 40 may further include a plurality of slab magnets 44 that may be mounted on both sides of non-magnetic conduit 42. In an exemplary embodiment, plurality of slab magnets 44 may be mounted along a length of non-magnetic conduit 42 with a predetermined longitudinal distance between each pair of adjacent slab magnets of plurality of slab magnets 44. For example, slab magnet 440 may be mounted at a predetermined longitudinal distance 442 from slab magnet 444. In an exemplary embodiment, predetermined longitudinal distance 442 may be between a quarter of a width 448 of each slab magnet and a half of width 448. In an exemplary embodiment, each slab magnet may have a predetermined length 446, which may depend at least in part on a total length of non-magnetic conduit 42.

In an exemplary embodiment, each pair of slab magnets at either sides of non-magnetic conduit 42 may be aligned along an axis perpendicular to longitudinal axis 420 of non-magnetic conduit 42. For example, slab magnet 440 may be aligned with slab magnet 443 at opposite sides of non-magnetic conduit 42. In an exemplary embodiment, opposite pairs of slab magnets may be polarized such that opposite poles may face towards non-magnetic conduit 42. For example, north pole of slab magnet 440 may face non-magnetic conduit 42, while south pole of slab magnet 443 may face non-magnetic conduit 42. In an exemplary embodiment, next pair of adjacent slab magnets may be polarized oppositely. For example, in the example presented above, south pole of slab magnet 444 may face non-magnetic conduit 42, while a north pole of slab magnet 445 may face non-magnetic conduit 42. In an exemplary embodiment, such arrangement of slab magnets around non-magnetic conduit 42 may allow for application of magnetic fields on livestock and poultry feed that may be received in system 40.

In an exemplary embodiment, system 40 may further include a feeding funnel 48, through which livestock and poultry feed 46 may be transferred into non-magnetic conduit 42 of system 40. In an exemplary embodiment, livestock and poultry feed 46 may be transported from a silo to feeding funnel 48 utilizing a conveying mechanism, such as a screw conveyor. After passing through the magnetic field or fields provided by plurality of slab magnets 44, the feed will move to the section where it can be used by poultry, livestock or aquatic animals.

In an exemplary embodiment, system 40 may further include an iron shield 45 that may be disposed around non-magnetic conduit 42. In an exemplary embodiment, iron shield 45 may extend along longitudinal axis 420 of non-magnetic conduit 42. Plurality of slab magnets 44 may be disposed between iron shield 45 and non-magnetic conduit 42. Referring to FIG. 4B, in an exemplary embodiment, iron shield 45 may have a square or rectangular cross-section that may concentrically be positioned around non-magnetic conduit 42, which also may have a square or rectangular cross-section. As used herein, a longitudinal axis of an object is an axis associated with the longest dimension of that object.

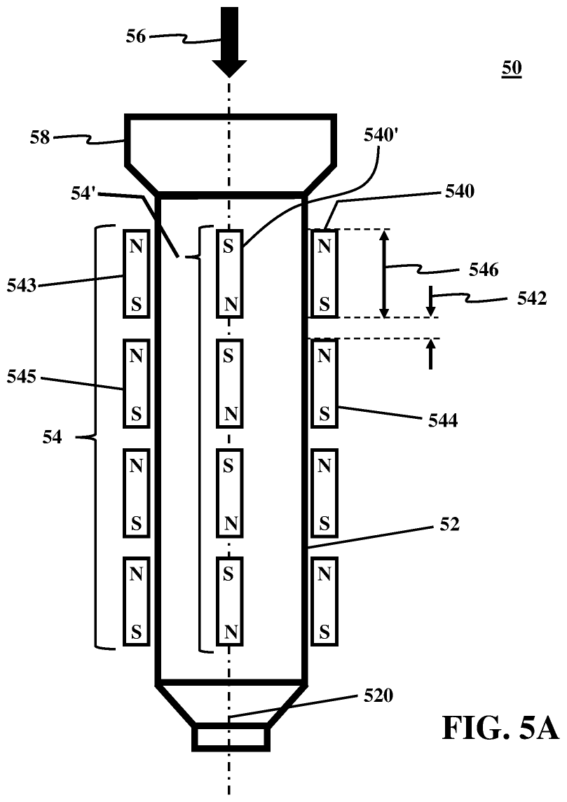

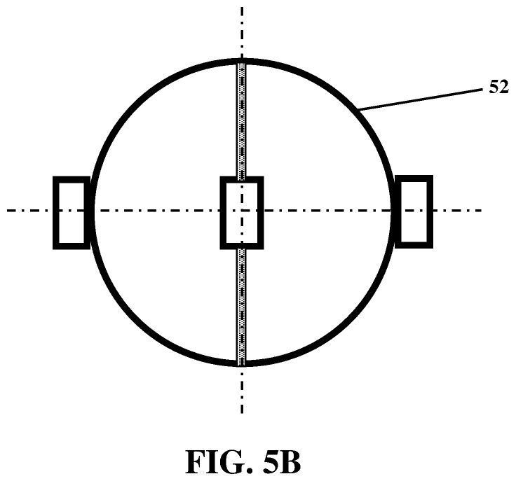

FIG. 5A illustrates a schematic sectional side view of a system 50 for improving livestock and poultry feed utilizing bar magnets, consistent with one or more exemplary embodiments of the present disclosure. FIG. 5B illustrates a schematic sectional top view of system 50 for improving livestock and poultry feed utilizing bar magnets, consistent with one or more exemplary embodiments of the present disclosure.

In an exemplary embodiment, system 50 may be configured similar to system 10 and system 40 to apply magnetic fields on livestock and poultry feeds. In an exemplary embodiment, system 50 may include a non-magnetic conduit 52 similar to non-magnetic conduit 12, which may be configured for receiving and holding livestock and poultry feed during treatment with magnetic fields. In an exemplary embodiment, system 50 may further include a plurality of magnet bars 54 that may be mounted on both sides of non-magnetic conduit 52. In an exemplary embodiment, plurality of magnet bars 54 may be mounted along a length of non-magnetic conduit 52 with a predetermined longitudinal distance between each pair of adjacent magnet bars of plurality of magnet bars 54. For example, magnet bar 540 may be mounted at a predetermined longitudinal distance 542 from magnet bar 544. In an exemplary embodiment, each magnet bar of plurality of magnet bars 54 may have a predetermined length 546 (referred to herein with symbol Lₘ) that may be between 20 mm and 200 mm. In an exemplary embodiment, the predetermined longitudinal distance between each pair of adjacent magnet bars of plurality of magnet bars 54 may be between Lₘ/8 and Lₘ/4.

In an exemplary embodiment, each pair of magnet bars at either sides of non-magnetic conduit 52 may be aligned along an axis perpendicular to longitudinal axis 520 of non-magnetic conduit 52. For example, magnet bar 540 may be aligned with magnet bar 543 at opposite sides of non-magnetic conduit 52. In an exemplary embodiment, plurality of magnet bars 54 may be polarized as illustrated in FIGS. 5A and 5B. In an exemplary embodiment, such arrangement of magnet bars around non-magnetic conduit 52 may allow for application of magnetic fields on livestock and poultry feed that may be received in system 50. In an exemplary embodiment, system 50 may further include a plurality of magnet bars 54′ that may be mounted in the middle of non-magnetic conduit 52 along longitudinal axis 520. In an exemplary embodiment, polarity of each middle magnet bar of plurality of magnet bars 54′ may be opposite the polarities of corresponding pair of bar magnets of plurality of magnet bars 54. For example, polarity of bar magnet 540′ may be opposite the polarity of magnet bar 540 and magnet bar 543.

In an exemplary embodiment, system 50 may further include a feeding funnel 58, through which livestock and poultry feed 56 may be transferred into non-magnetic conduit 52 of system 50. In an exemplary embodiment, livestock and poultry feed 56 may be transported from a silo to feeding funnel 58 utilizing a conveying mechanism, such as a screw conveyor. After passing through the magnetic field or fields provided by plurality of magnet bars 54 and plurality of magnet bars 54′, the feed will move to the section where it can be used by poultry, livestock or aquatic animals.

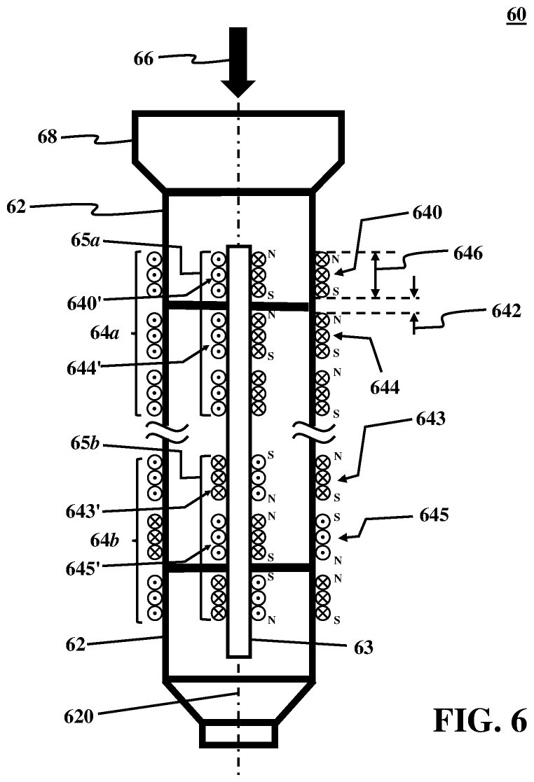

FIG. 6 illustrates a schematic sectional side view of a system 60 for improving livestock and poultry feed utilizing at least one electromagnet, consistent with one or more exemplary embodiments of the present disclosure. In an exemplary embodiment, system 60 may be configured similar to systems 10, 40, and 50 to apply magnetic fields on livestock and poultry feed. In an exemplary embodiment, system 60 may include a non-magnetic conduit 62 similar to non-magnetic conduit 12, which may be configured for receiving and holding livestock and poultry feed during treatment with magnetic fields. In an exemplary embodiment, system 60 may further include a plurality of electromagnets (64a, 64b, 65a, 65b) that may be wound around non-magnetic conduit 62 and around a magnet support 63 mounted within non-magnetic conduit 62. In an exemplary embodiment, magnet support 63 may be coaxially mounted within non-magnetic conduit 62. For example, plurality of electromagnets (64a, 64b) may be wound around an outer surface of non-magnetic conduit 62 and plurality of electromagnets (64a, 64b) may be wound around magnet support 63. Consequently, plurality of electromagnets (64a, 64b) may be encompassed by non-magnetic conduit 62. As illustrated in FIG. 6, conductive wires wound around non-magnetic conduit 62 and magnet support 63 are designated by small circles with dots and crosses inside the small circles. As used herein, the dots and crosses are indicative of the current direction. Specifically, circles with dots designate a current direction towards the view and circles with cross designate a current direction away from view. Polarities for each coil of conductive wire are further designated by N's for north poles and S's for south poles. The polarity of the electromagnet formed by each coil is determined by the current direction within that coil. For example, for coil 640 which may form an electromagnet, when viewed from top, the current is counterclockwise and therefore the north pole (N) is at the top and the south pole (S) is at the bottom.

In an exemplary embodiment, system 60 may further include a feeding funnel 68, through which livestock and poultry feed 66 may be transferred into non-magnetic conduit 62 of system 60. In an exemplary embodiment, livestock and poultry feed 66 may be transported from a silo to feeding funnel 68 utilizing a conveying mechanism, such as a screw conveyor. After passing through the magnetic field or fields provided by electromagnet 64, the feed will move to the section where it can be used by poultry, livestock or aquatic animals.

In an exemplary embodiment, plurality of electromagnets (64a, 64b, 65a, 65b) may be mounted along a length of non-magnetic conduit 62 with a predetermined longitudinal distance between each pair of adjacent electromagnet coils of plurality of electromagnets (64a, 64b, 65a, 65b). For example, electromagnet coil 640 may be mounted at a predetermined longitudinal distance 642 from electromagnet coil 644. In an exemplary embodiment, each electromagnet coil of plurality of electromagnets (64a, 64b, 65a, 65b) may have a predetermined length (Lₘ) 646 that may be between 20 mm and 200 mm. In an exemplary embodiment, the predetermined longitudinal distance between each pair of adjacent electromagnet coils of plurality of electromagnets (64a, 64b, 65a, 65b) may be between Lₘ/8 and Lₘ/4.

In an exemplary embodiment, a first plurality of electromagnets 64a may be configured such that each pair of adjacent electromagnet coils of first plurality of electromagnets 64a may be facing each other with sides having opposite polarities. For example, electromagnetic coil 640 may be facing electromagnetic coil 644 with opposite S and N polarities. In an exemplary embodiment, a second plurality of electromagnets 64b may be configured such that each pair of adjacent electromagnet coils of second plurality of electromagnets 64b may be facing each other with sides having similar polarities. For example, electromagnetic coil 643 may face electromagnetic coil 645 with similar S poles.

In an exemplary embodiment, such arrangement may be vice versa, i.e. each pair of adjacent electromagnet coils of first plurality of electromagnets 64a may be facing each other with sides having similar polarities. In an exemplary embodiment, a second plurality of electromagnets 64b may be configured such that each pair of adjacent electromagnet coils of second plurality of electromagnets 64b may be facing each other with sides having opposite polarities. However, for the sake of simplicity only one arrangement is discussed here.

In an exemplary embodiment, a third plurality of electromagnets 65a may be configured such that each pair of adjacent electromagnet coils of third plurality of electromagnets 65a may be facing each other with sides having opposite polarities. For example, electromagnetic coil 640′ may face electromagnetic coil 644′ with opposite S and N polarities. In an exemplary embodiment, a fourth plurality of electromagnets 65b may be configured such that each pair of adjacent electromagnet coils of fourth plurality of electromagnets 65b may be facing each other with sides having similar polarities. For example, electromagnetic coil 643′ may face electromagnetic coil 645′ with similar N polarities. In an exemplary embodiment, such arrangement may be vice versa, i.e. each pair of adjacent electromagnet coils of third plurality of electromagnets 65a may be facing each other with sides having similar polarities. In an exemplary embodiment, a fourth plurality of electromagnets 65b may be configured such that each pair of adjacent electromagnet coils of fourth plurality of electromagnets 64b may be facing each other with sides having opposite polarities. However, for the sake of simplicity only one arrangement is discussed here.

According to one or more exemplary embodiments, the present disclosure is further directed to a method for improving livestock and poultry feed by subjecting livestock and poultry feed to magnetic fields for a predetermined amount of time in order to weaken complex bonds within constituents of the livestock and poultry feed. In an exemplary embodiment, an exemplary method for improving livestock and poultry feed may include generating a magnetic field in livestock and poultry feed by arranging a plurality of magnets around a conduit containing the livestock and poultry feed. In an exemplary embodiment, plurality of magnets may be mounted along a length of the conduit with a predetermined longitudinal distance between each pair of magnets of the plurality of magnets. In an exemplary embodiment, the plurality of magnets may include at least one of a plurality of axially magnetized magnet rings, a plurality of slab magnets, a plurality of magnet bars, and an electromagnet.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, the word “substantially” when used with an adjective or adverb is intended to enhance the scope of the particular characteristic; e.g., substantially planar is intended to mean planar, nearly planar and/or exhibiting characteristics associated with a planar element. Further use of relative terms such as “vertical”, “horizontal”, “up”, “down”, and “side-to-side” are used in a relative sense to the normal orientation of the apparatus.

1. A system for improving livestock and poultry feed, comprising:
a non-magnetic conduit;
a feeding mechanism configured to transfer livestock and poultry feed into the non-magnetic conduit; and
a magnetic fields generation mechanism comprising a plurality of magnets arranged around the non-magnetic conduit, the magnetic fields generation mechanism configured to subject the transferred livestock and poultry feed to magnetic fields.

2. The system of claim 1, wherein the magnetic field generation mechanism comprises a plurality of axially magnetized permanent magnet rings, each permanent magnet ring fitted coaxially around the non-magnetic conduit, the plurality of axially magnetized permanent magnet rings mounted along a length of the non-magnetic conduit with a predetermined longitudinal distance between each pair of adjacent axially magnetized permanent magnet rings of the plurality of axially magnetized permanent magnet rings.

3. The system of claim 2, wherein the plurality of axially magnetized permanent magnet rings are mounted on the non-magnetic conduit with an axis of symmetry of each axially magnetized permanent magnet ring of the plurality of axially magnetized permanent magnet rings parallel with a longitudinal axis of the non-magnetic conduit, a central hole of each axially magnetized permanent magnet ring of the plurality of axially magnetized permanent magnet rings encompassing the non-magnetic conduit.

4. The system of claim 3, wherein each axially magnetized permanent magnet ring of the plurality of axially magnetized permanent magnet rings comprises a first face with a first polarity and a second face with a second polarity, the first face and the second face perpendicular to the axis of symmetry of the permanent magnet ring.

5. The system of claim 4, wherein each pair of adjacent axially magnetized permanent magnet rings of the plurality of axially magnetized permanent magnet rings are facing each other with faces having opposite polarities.

6. The system of claim 4, wherein each pair of adjacent axially magnetized permanent magnet rings of the plurality of axially magnetized permanent magnet rings are facing each other with faces having similar polarities.

7. The device of claim 4, wherein the plurality of axially magnetized permanent magnet rings comprises:
a first axially magnetized permanent magnet ring; and
a second axially magnetized permanent magnet ring positioned at the predetermined longitudinal distance away from the first axially magnetized permanent magnet ring,
wherein, a first face of the first axially magnetized permanent magnet ring with a first polarity is positioned facing a second face of the second axially magnetized permanent magnet ring with a second polarity, the first polarity and the second polarity are opposite polarities.

8. The system of claim 7, wherein an inner diameter of each axially magnetized permanent magnet ring of the plurality of axially magnetized permanent magnet rings is equal to an outer diameter of the non-magnetic conduit.

9. The system of claim 7, further comprising an elongated housing coaxially disposed around the non-magnetic conduit, the elongated housing extended along the longitudinal axis of the non-magnetic conduit, the elongated housing coaxial with and encompassing the plurality of axially magnetized permanent magnet rings such that the plurality of axially magnetized permanent magnet rings are disposed between the elongated housing and the non-magnetic conduit.

10. (canceled)

11. The system of claim 1, wherein the magnetic field generation mechanism comprises a plurality of slab magnets arranged around the non-magnetic conduit, the plurality of slab magnets mounted along a length of the non-magnetic conduit with a predetermined longitudinal distance between each pair of adjacent slab magnets of the plurality of slab magnets.

12. The system of claim 11, wherein each slab magnet of the plurality of slab magnets is mounted between an outer surface of the non-magnetic conduit and an inner surface of an iron shield.

13. The system of claim 12, wherein the plurality of slab magnets comprise pairs of slab magnets mounted on opposite sides of the outer surface of the non-magnetic conduit with each pair of oppositely mounted slab magnets facing each other with opposite poles.

14. The system of claim 1, wherein the magnetic field generation mechanism comprises a plurality of magnet bars arranged around the non-magnetic conduit, the plurality of magnet bars mounted along a length of the non-magnetic conduit with a predetermined longitudinal distance between each pair of adjacent magnet bars of the plurality of magnet bars.

15. The system of claim 14, wherein the magnetic field generation mechanism further comprises a plurality of magnet bars mounted within the non-magnetic conduit along the length of the non-magnetic conduit.

16. The system of claim 1, wherein the magnetic field generation mechanism comprises a plurality of electromagnet coils arranged around the non-magnetic conduit, the plurality of electromagnet coils mounted along a length of the non-magnetic conduit with a predetermined longitudinal distance between each pair of adjacent electromagnet coils of the plurality of electromagnet coils.

17. The system of claim 16, wherein the magnetic field generation mechanism further comprises a plurality of electromagnetic coils mounted on a magnet support within the non-magnetic conduit along the length of the non-magnetic conduit.

18. A method for improving livestock and poultry feed, the method comprising:
generating a magnetic field in livestock and poultry feed by arranging a plurality of axially magnetized permanent magnet rings around a conduit containing the livestock and poultry feed, each permanent magnet ring of the plurality of axially magnetized permanent magnet rings fitted coaxially around the conduit, the plurality of axially magnetized permanent magnet rings mounted along a length of the conduit with a predetermined longitudinal distance between each pair of adjacent axially magnetized permanent magnet rings of the plurality of axially magnetized permanent magnet rings.

19. The method of claim 18, wherein arranging the plurality of axially magnetized permanent magnet rings around the conduit containing the livestock and poultry feed comprises arranging the plurality of axially magnetized permanent magnet rings such that each pair of adjacent axially magnetized permanent magnet rings of the plurality of axially magnetized permanent magnet rings are positioned at a predetermined longitudinal distance from each other and facing each other with faces having opposite polarities.

20. The method of claim 18, wherein arranging the plurality of axially magnetized permanent magnet rings around the conduit containing the livestock and poultry feed comprises arranging the plurality of axially magnetized permanent magnet rings such that each pair of adjacent axially magnetized permanent magnet rings of the plurality of axially magnetized permanent magnet rings are positioned at a predetermined longitudinal distance from each other and facing each other with faces having similar polarities.

21. The method of claim 18, wherein arranging the plurality of axially magnetized permanent magnet rings around the conduit containing the livestock and poultry feed comprises arranging the plurality of axially magnetized permanent magnet rings such that each pair of adjacent axially magnetized permanent magnet rings of the plurality of axially magnetized permanent magnet rings are positioned at a predetermined longitudinal distance between 2 mm and 10 mm from each other.

22. (canceled)
